(19) United States
(12) Patent Application Publication
(10) Pub. No.: US 2023/0022264 A1
(43) Pub. Date: Jan. 26, 2023

(54) SYSTEMS AND METHODS FOR PERFORMING SEISMIC SURVEY IN SHALLOW WATER AREAS

(71) Applicant: Schlumberger Technology Corporation, Sugar Land, TX (US)

(72) Inventors: Nicolae Moldoveanu, Houston, TX (US); Maurice Nessim, Houston, TX (US)

(21) Appl. No.: 17/758,246

(22) PCT Filed: Jan. 7, 2021
(86) PCT No.: PCT/US2021/012422

§ 371 Date: Jun. 30, 2022

Related U.S. Application Data
(60) Provisional application No. 62/958,841, filed on Jan. 9, 2020.

(51) Int. Cl. G01V 1/38; G01V 1/42; G01V 1/36

(52) U.S. Cl. CPC G01V 1/3808; G01V 1/3852; G01V 1/42; G01V 1/36; G01V 2210/127; G01V 2210/1427

(57) ABSTRACT

A method may include receiving, via a processor, multiple seismic datasets acquired simultaneously in response to multiple seismic waves generated by multiple sources towed by one or more vessels. The multiple seismic datasets may include an ocean bottom node datasets, a towed streamer dataset, a near field hydrophones dataset, and a vertical seismic profile dataset. The method may sensors also include performing coordinated seismic data processing using the multiple seismic datasets to generate seismic data representative of one or more subsurface regions below the water bottom, building a velocity model based on the seismic data, and generating seismic images representative of the water bottom and the one or more subsurface regions based on the velocity model.

### CROSS-REFERENCE TO RELATED APPLICATIONS

This application claims priority to and the benefit of a U.S. Provisional Application having Ser. No. 62/958,841, filed on Jan. 9, 2020, which is incorporated by reference herein for all purposes.

### BACKGROUND

The present disclosure relates generally to performing multiple types of seismic surveys in shallow water. More specifically, the present disclosure relates to exploring shallow water complex geologic areas by combining multiple seismic measurements that may be acquired simultaneously during an ocean bottom node (OBN) survey.

This section is intended to introduce the reader to various aspects of art that may be related to various aspects of the present disclosure, which are described and/or claimed below. This discussion is believed to help provide the reader with background information to facilitate a better understanding of the various aspects of the present disclosure. Accordingly, it is understood that these statements are to be read in this light, and not as admissions of prior art.

Seismic exploration in shallow water areas having complex geological structures may be challenging. Shallow water properties and shallow geological complexities may create difficulties in seismic data acquisitions (e.g., surveys) and post-acquisition data processing (e.g., noise attenuation, subsurface imaging, velocity model building). Ocean bottom seismic acquisition techniques, such as dense grids of ocean bottom nodes (OBN) or ocean bottom cables (OBC) may provide solutions for seismic explorations in shallow water complex geologic areas. However, costs of deploying dense grids of OBN or OBC in shallow water areas may be prohibitive.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a system is provided. The system may include multiple sources, multiple ocean bottom nodes, and multiple streamer sensors. The multiple sources configured to generate source waves may include a first source and a second source each comprising multiple air guns. The multiple ocean bottom nodes may be configured to acquire a first set of seismic data in response to the source waves being generated by the multiple sources. The multiple ocean bottom nodes may be positioned along multiple receiver lines parallel to each other on a water bottom. The multiple receiver lines may form a receiver patch. Each pair of adjacent receiver lines may be separated by a distance and each pair of adjacent ocean bottom nodes on a corresponding receiver line may be separated with the same distance. The multiple streamer sensors may be configured to acquire a second set of seismic data simultaneously while the multiple ocean bottom nodes are acquiring the first set of data. The multiple streamer sensors may be disposed on multiple streamers including a first group of streamers and a second group of streamers. The first source and the first group of streamers may be towed by a first vessel and the second source and the second group of streamers may be towed by a second vessel. The first vessel and the second vessel may be configured to sail along a sail line direction outside area including the receiver patch. The sail line direction may be parallel to the multiple receiver lines of the receiver patch.

In another embodiment, a method is provides. The method may include receiving, via a processor, multiple seismic datasets acquired simultaneously in response to seismic waves generated by multiple sources towed by one or more vessels sailing along a sail line direction. The multiple seismic datasets may include a first seismic dataset acquired from a receiver patch including multiple ocean bottom nodes positioned on multiple lines parallel to each other and parallel to the sail line direction on a water bottom, a second seismic dataset acquired from multiple streamers towed by the one or more vessels while sailing along the sail line direction and outside the receiver patch, a third seismic dataset acquired from multiple near field hydrophones positioned adjacent to at least one of the multiple sources, and a fourth seismic dataset acquired from multiple vertical seismic profile sensors disposed in one or more wells located within the receiver patch. The method may also include performing, via the processor, coordinated seismic data processing using the multiple seismic datasets to generate seismic data representative of one or more subsurface regions below the water bottom. The method may also include building, via the processor, a velocity model based on the seismic data. The velocity model may include a map of one or more velocity vectors within the one or more subsurface regions. The method may further include generating, via the processor, one or more seismic images based on the velocity model. The one or more images may be representative of the water bottom and the one or more subsurface regions.

In yet another embodiment, a non-transitory computer-readable medium is provided. The medium includes instructions that, when executed, cause a processor to perform operations. The operations may include receiving multiple seismic datasets acquired simultaneously in response to seismic waves generated by multiple sources towed by one or more vessels sailing along a sail line direction. The multiple seismic datasets may include a first seismic dataset acquired from a receiver patch including multiple ocean bottom nodes positioned on multiple lines parallel to each other and parallel to the sail line direction on a water bottom, a second seismic dataset acquired from multiple streamers towed by the one or more vessels while sailing along the sail line direction and outside the receiver patch, a third seismic dataset acquired from multiple near field hydrophones positioned adjacent to at least one of the multiple sources, and a fourth seismic dataset acquired from multiple vertical seismic profile sensors disposed in one or more wells located within the receiver patch. The operations may also include performing coordinated seismic data processing using the multiple seismic datasets to generate seismic data representative of one or more subsurface regions below the water bottom. The operations may also include building a velocity model based on the seismic data. The velocity model may include a map of one or more velocity vectors within the one or more subsurface regions. Building the velocity model may include calibrating multiple parameters of the velocity model based on the fourth dataset. The multiple parameters may include a velocity parameter, an anisotropy parameter, and one or more attenuation factors of the one or more subsurface. The operations may further include generating, via the processor, one or more seismic images based on the velocity model. The one or more images may be representative of the water bottom and the one or more subsurface regions.

### BRIEF DESCRIPTION OF THE DRAWING

These and other features, aspects, and advantages of the present disclosure will become better understood when the following detailed description is read with reference to the accompanying drawings in which like characters represent like parts throughout the drawings, wherein:

FIG. 1 illustrates a schematic diagram of a shallow water seismic survey using multiple seismic measurements, in accordance with embodiments described herein;

FIG. 2 illustrates an example of ocean bottom node (OBN) measurement employed in the shallow water seismic survey of FIG. 1, in accordance with embodiments described herein;

FIG. 3A illustrates an example of a streamer measurement simultaneously acquired with the OBN measurement of FIG. 2, in accordance with embodiments described herein;

FIG. 3B illustrates another example of a streamer measurement simultaneously acquired with the OBN measurement of FIG. 2, in accordance with embodiments described herein;

FIG. 4 illustrates an example of an inline offset measurement using streamers employed on the same side of an OBN patch, in accordance with embodiments described herein;

FIG. 5 illustrates an example of an crossline offset measurement using streamers employed on both sides of an OBN patch, in accordance with embodiments described herein;

FIG. 6 illustrates an example of near-field hydrophone (NFH) measurement simultaneously acquired with the OBN measurement and the streamer measurement, in accordance with embodiments described herein;

FIG. 7 illustrates an example of vertical seismic profile (VSP) measurement simultaneously acquired with the OBN measurement, the streamer measurement, and the NFH measurement, in accordance with embodiments described herein;

FIG. 8 illustrates an example of multiple VSPs simultaneously acquired with the OBN measurement to generate a continuous image of a reservoir in an obstructed area, in accordance with embodiments described herein; and

FIG. 9 illustrates a flow diagram of a process for processing the multiple seismic measurements acquired in the shallow water seismic survey of FIG. 1, in accordance with embodiments described herein.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. It should be noted that the term “multimedia” and “media” may be used interchangeably herein.

Prospecting for hydrocarbon deposits (e.g., oil and gas) often involves seismic exploration to determine subterranean geologic structures (e.g., subsurface layers or formations) by means of prospector-induced seismic waves. The seismic exploration may use a seismic survey to acquire seismic data for investigating subterranean structures related to hydrocarbons. For example, during a land (onshore) or a marine (offshore) seismic survey, the prospector-induced seismic waves (e.g., elastic or acoustic waves) may be generated by seismic sources (e.g., dynamite, electric vibrators, or air guns) located at selected shot points. The seismic waves may propagate downward into the subterranean geologic structures, which may change propagation directions (e.g., via reflections or refractions) and physical properties (e.g., amplitudes, phases, polarities) of the seismic waves due to changes in elastic properties (e.g., velocities, densities, or impedances) of the subterranean geologic structures. Reflected or refracted seismic waves may propagate to pre-deployed sensors (e.g., geophones, accelerometers, hydrophones, fiber-optic sensors) that may detect and convert a portion of elastic or acoustic energy into signals recorded as the seismic data. The seismic data may be used to estimate geophysical properties (e.g., locations, formations, shapes) of the subterranean geologic structures. For example, the seismic data may be used to determine the locations of the subsurface layers or formations based on time intervals elapsing between initiations of seismic waves at the selected shot locations and arrivals of reflected or refracted seismic impulses detected at one or more sensors.

In shallow water areas (e.g., water depth between approximately 5 and 150 meters) having complex geological structures (e.g., salt bodies, high velocity layers, or thin impedance layers) under a water bottom may prove to be difficult to survey. For example, a reservoir may be located at depth between 3000 meters to 7000 meters and may have structural and/or stratigraphic complexity. In some cases, a complex overburden (e.g., rock or soil lying above a mineral deposit) covering the reservoir may consist of variable shape salt bodies, high velocity layers (e.g., carbonate or anhydrites), and thin high impedance shallow layers, which may generate strong surface and internal multiples.

Multiples, including surface multiples (e.g., free surface related multiples) and internal multiples (e.g., inter-bed multiples), are echoes or reverberations associated with primary reflections (e.g., reflections occurring at subsurface layers). The multiples are generally unwanted and their presence may mask or interfere with underlying primary reflections. For example, the primary reflections may be weaker in amplitude with the presence of surface and/or internal multiples. Without proper attenuations, these multiples may result in reduced-quality or inaccurate reservoir images.

Geophysical challenges related to seismic exploration in shallow water complex geologic areas may include generating high quality imaging of the water bottom and the geologic layers positioned near the surface of the water bottom. In addition, the shallow water properties and the complex overburden may create challenges in seismic data processing and interpretation, such as attenuating the surface and internal multiples, building an accurate velocity depth model that may be used in migration for imaging the subsurface layers or formations, accurately determining seismic amplitudes that may allow for reservoir characterization type studies, and the like. Beside the geologic and geophysical challenges, natural and man-made obstructions (e.g., coral reefs, platforms, rigs, vessel traffic) may be present in the area, thereby further reducing the effectiveness of seismic surveys performed in the shallow water areas.

With the foregoing in mind, to more accurately perform seismic surveys in these shallow water complex geologic areas (e.g., Gulf of Suez, Read Sea (shallow water part), Gulf of Mexico (Southern side), West Africa (Angola)), ocean bottom acquisition systems that employ ocean bottom node (OBN) or ocean bottom cable (OBC) may be utilized to obtain more accurate seismic survey data. For example, seismic acquisition techniques employing OBNs in shallow water having complex geologic structures may involve deploying a dense grid (e.g., grid sizes in two orthogonal directions are less than 100 meters) of OBNs and a dense grid of sources to effectively image the subsurface from the water bottom to a certain depth (e.g., a maximum depth of a reservoir).

However, deploying a dense grid of OBNs in shallow water may prove to be a cost prohibitive solution for performing seismic survey operations in shallow waters. For example, a dense OBN survey in shallow waters may involve intensive use of remotely operated vehicles (ROVs) for OBN deployment. On the other hand, if larger receiver spacing is used between the OBNs, the imaging of the water bottom and the shallow geological layers may be compromised and may not yield an accurate representation of the formations that are present in the subsurface of the shallow water areas. That is, the larger receiver spacing may limit the ability of seismic data processing to attenuate multiples that may be present in the acquired seismic data and may produce an inaccurate velocity depth model, thereby yielding an inaccurate depth image of the subsurface.

Keeping the foregoing in mind, in certain embodiments, seismic data may be simultaneously acquired from one or more streamer sensors disposed on seismic streamers traversing the shallow water during a seismic survey (e.g., as sources are fired), along with seismic data acquired by OBN sensors in OBNs positioned on the water bottom of the shallow water. For example, one or more source vessels may be equipped with air guns firing at selected times and locations. The arrivals of reflected or refracted seismic impulses may be detected by the OBN sensors as well as the streamer sensors. In some embodiments, near-field hydrophones (NFH) may be used to simultaneously acquire seismic data related to the reflected seismic impulses. In addition to the OBN sensors, the streamer sensors, and the NFHs, in some embodiments, seismic data may also be simultaneously acquired via fiber-optic sensors, hybrid sensors (e.g., combining fiber-optic sensors and geophones), or other suitable seismic sensors disposed in a vertical orientation (e.g., within a well) to obtain vertical seismic profile (VSP) data that may be used to calibrate travel times, amplitudes, reflectors, and other relevant seismic data properties related to the other simultaneously acquired seismic data from the other sensors.

By coordinating the simultaneous acquisition of seismic data via the OBNs, the seismic streamers and the NFHs, the OBNs may be positioned with more distance apart (e.g., 200 m×200 m) from each other as compared to performing the seismic data acquisition operations in shallow water using an OBN survey. That is, the less dense OBN geometry may still produce accurate seismic images of the subsurface region in shallow water areas by performing a coordinated seismic data processing using the seismic data acquired simultaneously from the different sensors. Moreover, the surface and internal multiples may be attenuated more effectively using the seismic data simultaneously acquired from the different sensors. Additionally, by employing the sensors disposed in a vertical arrangement, surface seismic data may be calibrated using 3D VSP data in terms of travel times and amplitudes, thereby improving the accuracy of reservoir characterization type studies. As a result, the present embodiments described herein enable improved accuracy of anisotropy estimations, attenuation factor (Q value) estimations, horizon identifications, and resolution of reservoir images, in addition to reducing an amount of time employed for seismic exploration and reduced cost associated with using fewer OBNs as compared to previous seismic data acquisition techniques in shallow water areas.

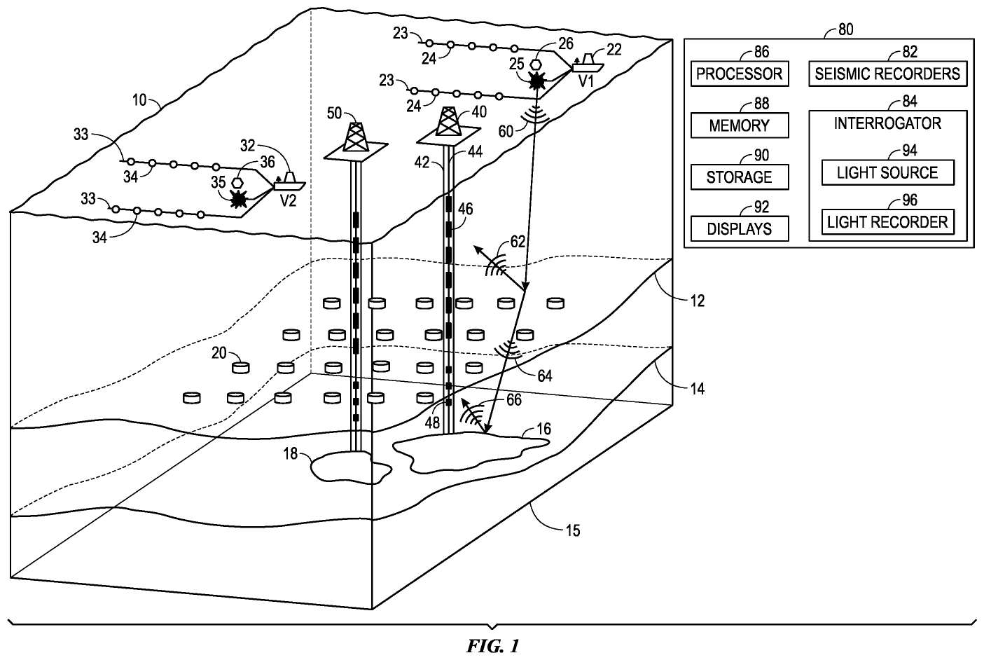

With the preceding in mind, turning now to the figures, FIG. 1 illustrates a schematic diagram of a shallow water seismic survey using multiple seismic measurements. A shallow water area may include a surface 10 and a water bottom 12. Water depth in the shallow water area may vary from a few meters to 150 meters. Multiple subsurface layers (e.g., subsurface layers 14 and 15) may locate beneath the water bottom 12. Geological formations, such as subsurface formations 16 and 18 embedded in the subsurface layers, may contain hydrocarbon deposits. Seismic data acquired in the shallow water seismic survey may be used to image the water bottom 12, the subsurface layers 14 and 15, and the subsurface formations 16 and 18. Images of subterranean geologic structures may provide indications of the hydrocarbon deposits.

The shallow water seismic survey may include ocean bottom node (OBN) measurement by employing multiple OBNs 20 on the water bottom 12. The OBNs may be deployed (e.g., using remotely operated vehicles (ROVs)) to selected locations and form a certain geometry (e.g., an OBN patch with 200 meters by 200 meters grid size). Each of the OBNs 20 may include one or more OBN sensors. The OBN sensors may include one or more geophones (e.g., single-component, two-component, three-component geophones). In some embodiments, the OBN sensors may also include hydrophones.

One or more seismic source vessels may be used in the shallow water seismic survey. For example, a source vessel 22 towing a seismic source 25 and another source vessel 32 towing another seismic source 35 may be used to create seismic waves propagating downward into the subterranean geologic structures. Each of the seismic sources 25 and 35 may include one or more source arrays and each source array may include a certain number of air guns.

The shallow water seismic survey may also include streamer measurement by employing multiple streamers traversing the shallow water. For example, the source vessel 22 may tow multiple (e.g., two, four, six, eight, or ten) streamers 23 along one sail line, and the source vessel 32 may tow multiple streamers 33 along another sail line. The streamer measurement may be acquired simultaneously with the OBN measurement using shots fired by the seismic sources 25 and 35. Each streamer may include multiple streamer sensors. For example, each of the streamers 23 may include streamer sensors 24 and each of the streamers 33 may include streamer sensors 34. The streamer sensors 24 and 34 may include hydrophones that create electrical signals in response to water pressure changes caused by reflected seismic waves that arrive at the hydrophones.

The shallow water seismic survey may also include near field hydrophone (NFH) measurement by employing multiple NFHs close to the seismic sources. For example, an NFH 26 may be deployed in close proximity to the seismic source 25 and another NFH 36 may be deployed in close proximity to the seismic source 35. In a shallow water environment, the NFH measurement may be used to improve estimates of near surface conditions and to create more accurate shallow velocity models. Moreover, the NFH measurement may provide small-offset data missing from streamer measurement that may be useful for multiple attenuation. Offset may be referred to as a distance between a seismic source and a seismic receiver or sensor. The NFH measurement may be combined with streamer measurement to improve seismic data processing such as multiple attenuation, wavelet estimation, and de-bubble.

The shallow water seismic survey may further include vertical seismic profile (VSP) measurement by employing seismic sensors (e.g., fiber-optic sensors, geophones, or hybrid sensors) in one or more wells. For example, a hybrid sensor array including fiber-optic sensors 46 and geophones 48 may be disposed along a wireline cable 44 deployed in a borehole 42 of a well 40, which may be drilled into the subsurface formation 16. Similar seismic sensors may be deployed in another well 50, which may be drilled into the formation 18. The fiber-optic sensors 46 may measure strains caused by reflected or refracted seismic waves traveling along the hybrid sensor array. The geophone 48 may measure ground motions (e.g., particle movements such as velocity and acceleration) caused by seismic waves traveling along the hybrid sensor array.

During the shallow water seismic survey, the seismic source 25 may be activated to generate seismic waves 60 traveling downward into the subterranean geologic structures. When the seismic waves 60 arrives at the water bottom 12, a portion of seismic energy contained in the seismic waves 60 is reflected by the water bottom 12. Reflected waves 62 travel upward and arrive at different sensors, such as the streamer sensors 24 and 34, the near field hydrophones 26 and 36, and the fiber-optic sensors 46, where they are measured by corresponding sensors. Another portion of the seismic energy contained in transmitted seismic waves 64 propagated through the water bottom 12 into the subsurface layer 14. A portion of seismic energy contained in the transmitted waves 64 is reflected by the subsurface formation 16. Reflected waves 66 travel upward and arrive at the different sensors, where they are measured by the corresponding sensors.

It should be noted that the elements described above with regard to the shallow water seismic survey are exemplary elements. For instance, some embodiments of the shallow water seismic survey may include additional or fewer elements than those shown. In some embodiments, the shallow water seismic survey may include different number of source vessels. In some embodiments, separated receiver vessels may be used to tow the streamers. In some embodiments, the streamer measurement may be acquired independently from the OBN measurement for operational or logistical reasons.

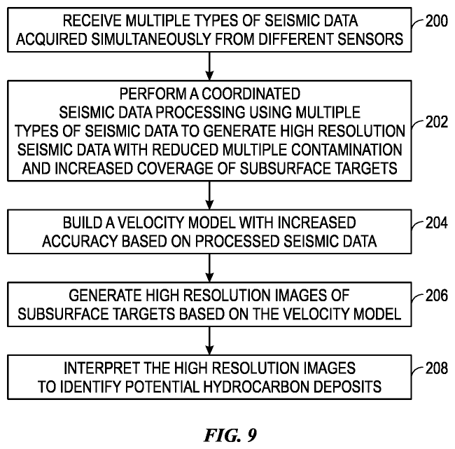

Seismic data simultaneously acquired from different sensors may be collected and processed by a processing system 80. The processing system 80 may include one or more seismic recorders 82, an interrogator 84, a processor 86, a memory 88, a storage 90, and one or more displays 92. The one or more seismic recorders 82 may receive ocean bottom node (OBN) data from OBNs 20, streamer data from streamer sensors 24 and 34, near field hydrophone (NFH) data from the NFHs 26 and 36, and a portion of vertical seismic profile (VSP) data from geophones 48. The interrogator 84 may receive another portion of VSP data from the fiber-optic sensors 46. Collected data may be processed by the processor 86 using processor-executable code stored in the memory 88 and the storage 90. The processed data may be stored in the storage 90 for later usage. Processing results may be displayed via the one or more displays 92. Data processing based on multiple measurements will be discussed in detail below with reference to FIG. 9.

The interrogator 84 may include a light source 94 that may provide source light signals (e.g., laser impulses) for the fiber-optic sensors 46. For example, the light source 94 may include wavelength tunable lasers (e.g., semiconductor lasers), such as distributed Bragg reflector (DBR) laser, vertical cavity surface-emitting laser (VCSEL), external cavity laser, distributed feedback (DFB) laser, or other suitable lasers. The interrogator 84 may also include a light recorder 96 that may receive light signals (e.g., back scattered light signals associated with local measurement of dynamic strains caused by incident seismic waves) from the fiber-optic sensors 46 and convert the light signals to electrical signals (e.g., using photodetectors).

The processor 86 may be any type of computer processor or microprocessor capable of executing computer-executable code. The processors 86 may include single-threaded processor(s), multi-threaded processor(s), or both. The processors 86 may also include hardware-based processor(s) each including one or more cores. The processors 86 may include general purpose processor(s), special purpose processor(s), or both. The processors 86 may be communicatively coupled to other components (such as one or more seismic recorders 82, interrogator 84, memory 88, storage 90, and one or more displays 92).

The memory 88 and the storage 90 may be any suitable articles of manufacture that can serve as media to store processor-executable code, data, or the like. These articles of manufacture may represent computer-readable media (e.g., any suitable form of memory or storage) that may store the processor-executable code used by the processor 86 to perform the presently disclosed techniques. The memory 88 and the storage 90 may also be used to store data described (e.g., fiber sensor data, geophone data), various other software applications for seismic data analysis and data processing. The memory 88 and the storage 90 may represent non-transitory computer-readable media (e.g., any suitable form of memory or storage) that may store the processor-executable code used by the processor 86 to perform various techniques described herein. It should be noted that non-transitory merely indicates that the media is tangible and not a signal.

The one or more displays 92 may operate to depict visualizations associated with software or executable code being processed by the processor 86. The display 66 may be any suitable type of display, such as a liquid crystal display (LCD), plasma display, or an organic light emitting diode (OLED) display.

It should be noted that the components described above with regard to the processing system 80 are exemplary components and the processing system 80 may include additional or fewer components as shown. For example, the processing system 80 may include one or more communication interfaces to send commands to different seismic acquisition systems and receive measurement from the different seismic acquisition systems.

As mentioned previously, ocean bottom acquisition systems including the ocean bottom node (OBN) or the ocean bottom cable (OBC) may be utilized to obtain more accurate seismic survey data in water complex geologic areas. For example, a seismic survey employing OBNs in shallow water having complex geologic structures may involve deploying an OBN patch (e.g., a 2D OBN array) and a dense grid of sources to effectively image the subsurface from the water bottom to a certain depth. The dense grid of sources may be produced by multiple seismic vessels sailing along one or more sides of the OBN patch.

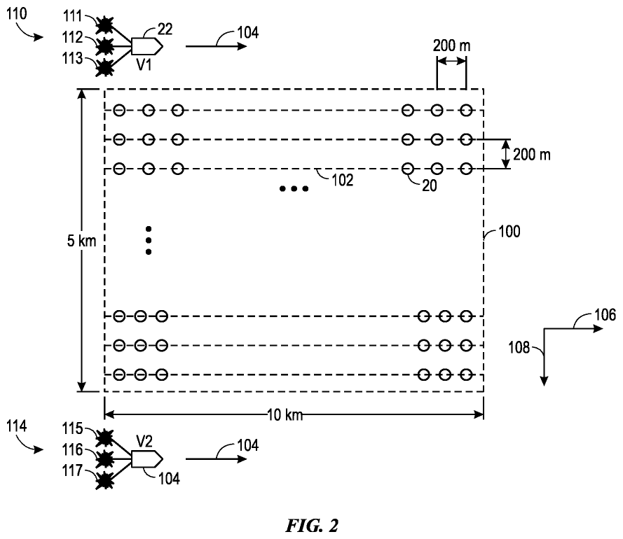

By way of introduction, FIG. 2 illustrates an example of ocean bottom node (OBN) measurement employed in the shallow water seismic survey. An OBN patch 100 may be deployed on the water bottom 12. The OBN patch 100 may include multiple (e.g., 25) receiver lines 102 each having a length of 10 kilometers. A distance between two adjacent receiver lines 102 is approximately 200 meters (e.g., 190-210 meters), thereby the OBN patch 100 including 25 receiver lines 102 may have a width of approximately 5 kilometers (e.g., 3-6 km). Two source vessels 22 and 32 may be used to produce source signals (e.g., seismic waves via air guns). The reflected or refracted seismic waves (e.g., reflected waves 66) may be detected by the OBNs 20 disposed along the receiver lines 102. The OBNs 20 may have a 200 meters×200 meters receiver (node) spacing. The source vessels 22 and 32 may move along a sail line direction 104 that is parallel to the receiver lines 102. The sail line direction 104 may be referred to as an inline direction 106. A direction perpendicular to the sail line direction 104 may be referred to as a crossline direction 108.

In some embodiments, each source vessel may be equipped with a triple source array. For example, a source array 110 towed by the source vessel 22 may include sources 111, 112, and 113 and another triple source array 114 towed by the source vessel 32 may include sources 115, 116, and 117. A distance between two adjacent sources (e.g., between sources 111 and 112 or sources 112 and 113) may be approximately 50 meters (e.g., 47.5-52.5 meters). An OBN source grid with a dense source sampling spacing may be used for the shallow water seismic survey. For example, a 37.5 meters×50 meters shot spacing may be used during the shallow water seismic survey if each source fires with a shot interval approximately 12.5 m (e.g., 12-13 meters) along the inline direction 106 in a flip-flop-flap mode (e.g., each of the sources 111, 112, and 113 firing alternatively).

As described previously, if larger receiver spacing (e.g., 200 meters×200 meters) is used between the OBNs, the imaging of the water bottom and the shallow geological structures may be compromised and may not yield an accurate representation of the subsurface formations that are present in the shallow water areas. However, by using the OBN source grid with a dense source sampling spacing, a less dense OBN geometry (e.g., large receiver spacing) may still produce accurate seismic images of the subsurface region in shallow water areas by performing a coordinated seismic data processing using the seismic data acquired simultaneously from the different sensors.

For example, high-resolution streamer data may be obtained by simultaneously acquiring streamer measurement with streamers towed by seismic vessels around the OBN patch 100. The coordinated seismic data processing using OBN and streamer data may yield high-resolution imaging of the water bottom and shallow geological structures. Moreover, dense sampling of sources for OBN and receiver measurements may enable applications of a generalized surface multiple attenuation method. For instance, a convolution of the high-resolution streamer data and OBN data may generate predicted OBN multiples. In some embodiments, two source vessels may be used to reduce the survey duration (as the battery life of the nodes is limited) and to reduce the survey cost. In some embodiments, using short streamers (e.g., streamer length less than 3 kilometers) may still produce long offset measurements.

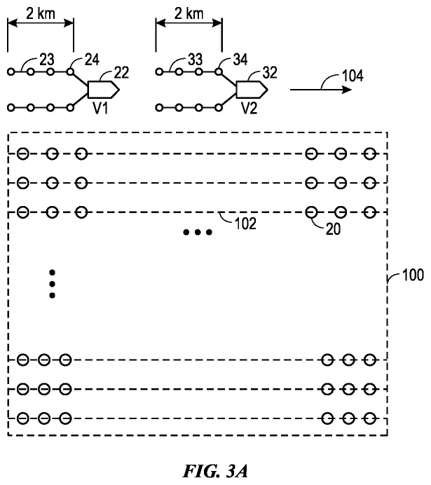

With this in mind, FIG. 3A illustrates an example of short streamer measurement simultaneously acquired with the OBN measurement. The source vessels 22 and 32 may be placed on a same side of the OBN patch 100. The source vessel 22 may tow two streamers 23 moving along the sail line direction 104 parallel to the receiver lines 102. Each streamer 23 may have a length of 2 kilometers and including multiple streamer sensors 24. Similarly, the source vessel 32 may tow two streamers 33 each having a length of 2 kilometers and including multiple streamer sensors 34.

FIG. 3B illustrates another example of short streamer measurement simultaneously acquired with the OBN measurement. The source vessels 22 and 32 may be placed on opposite sides of the OBN patch 100 and move along the sail line direction 104. Each of the source vessels 22 and 32 may tow two short streamers each having a length of approximately 2 kilometers.

To effectively perform the shallow water seismic survey using the source vessels 22 and 32, certain factors may be considered in a design of the streamer measurement. In some embodiments, a sail line interval (e.g., along the sail line direction 104) of streamer measurement may be the same as the sail line interval of the OBN measurement to determine a number of streamers and a streamer separation distance between each of the streamers. In addition, a source configuration for the OBN and streamer measurements should be identical, while the crossline separation between sources (e.g., sources 111 and 112) in a source array (e.g., source array 110) may assist in determining a crossline bin size for the streamer, unless the streamer separation is smaller than the source crossline separation.

In some embodiments, distances from a source array to the nearest and furthest streamers may be determined based on water depth, water velocity, and water bottom sediment velocity. For example, the distance from the source array to the nearest streamer should be small enough to allow recording of a pre-critical reflection at the streamers located furthest from the source array. It should be noted that, in some embodiments, the streamer length may be determined based on a maximum depth of a subsurface layer that corresponds to a desired image to be obtained using the streamer data.

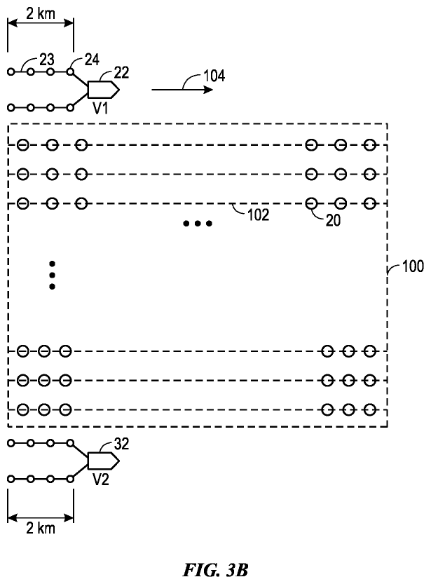

In some embodiments, the number of streamers and streamer length may be designed based on certain survey objectives. If the source vessels are on the same side of an OBN patch, longer and continuous offset measurements may be acquired using shorter streamers. FIG. 4 illustrates an example of a long (e.g., greater than the length of a streamer) inline offset measurement using short streamers employed on the same side of the OBN patch 100. For instance, if the streamers 23 and 33 have a length of 2 kilometers, and a separation between the streamers 23 and the streamers 33 is 2 kilometers, a long inline offset measurement with a maximum offset equal to 6 kilometers may be acquired from the seismic source 35 towed by the source vessel 32 at the streamers 23 towed by the source vessel 22.

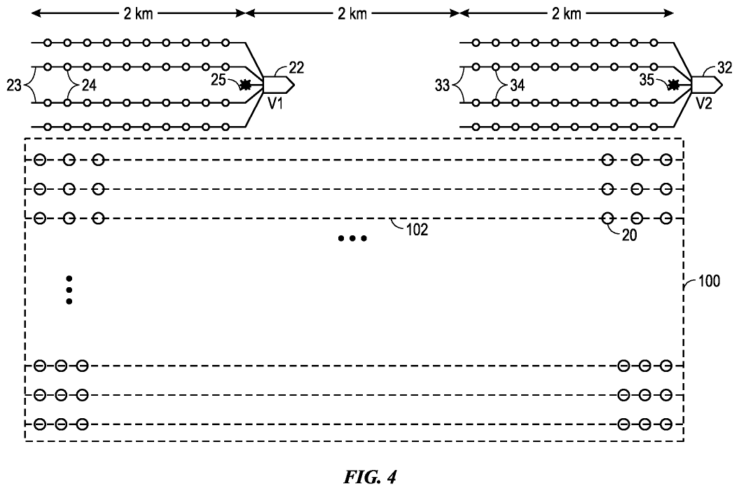

If the source vessels are on the opposite sides of the OBN patch, a relatively short inline offset and a long crossline offset measurement may be acquired using the same sources. FIG. 5 illustrates an example of a long crossline offset measurement using short streamers employed on both sides of the OBN patch 100. For instance, if the OBN patch 100 has a width of 8 kilometers, a long crossline offset measurement with a maximum offset equal to 8 kilometers may be acquired from the seismic source 25 towed by the source vessel 22 at the streamers 33 towed by the source vessel 32, or from the seismic source 35 towed by the source vessel 32 at the streamers 23 towed by the source vessel 22.

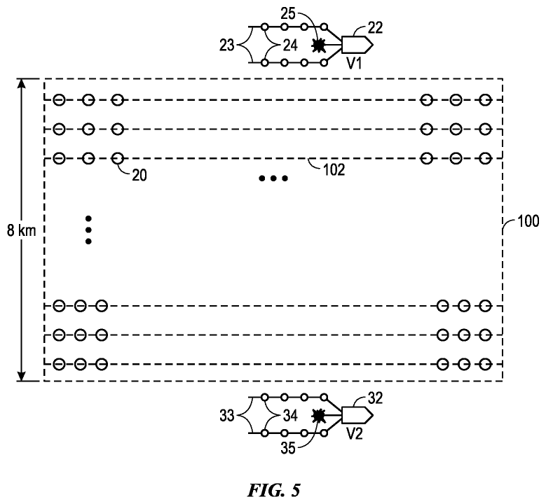

As mentioned above, near-field hydrophones (NFHs) may be used in shallow water seismic surveys to acquire seismic data that corresponds to seismic arrivals (e.g., reflected waves). The acquired seismic data may be processed along with the other simultaneously acquired seismic data (e.g., OBN and streamer data) to generate high-resolution seismic images representative of subterranean geologic structures. FIG. 6 illustrates an example of near-field hydrophone (NFH) measurement simultaneously acquired with the OBN measurement and the short streamer measurement. The NFHs may be disposed on source streamers connected to the sources (e.g., seismic sources 25 and 35), such that each NFH may be positioned adjacent to a corresponding source. For example, a NFH 26 may be positioned on a source streamer 118 and adjacent to the seismic source 25, and a NFH 36 may be positioned on a source streamer 119 and adjacent to the seismic source 35.

In some embodiments, each of the seismic sources 25 and 35 may include one or more source arrays (e.g., source arrays 110 and 114) and each source array may include a certain number of air guns. Each NFH may be positioned adjacent (e.g., above) to a corresponding air gun and may be used to measure seismic waves from every shot location. The measurement may be used to generate zero offset data. In some embodiments, the NFHs may be used to measure source signatures of source waves produce by respective sources. For example, near field signatures may be recorded for each air gun and each shot location, and the near field signatures may be processed to generate a high resolution zero-offset subsurface image.

In some embodiments, two source arrays or triple source arrays may be used in an OBN survey for each source vessel. The source arrays may be activated or fired sequentially. NFH data may be acquired in active arrays (e.g., that are firing) and also in passive arrays (e.g., that are inactive and listening). The NFH data acquired in active and passive arrays may then be used in seismic data processing in accordance with embodiments described above.

By using the NFH data to perform the seismic data processing, a high-resolution image of the water bottom 12 and subterranean geologic structures (e.g., subsurface layers 14 and 15, subsurface formations 16 and 18) below the water bottom 12 may be obtained. Moreover, the NFH data may be used for multiple attenuation processes, such as Deterministic Water Layer Deconvolution to guide seismic data extrapolation to zero offset. Additionally, the NFH data may be used for shallow water hazard detection. Such shallow water hazards may include faults, gas-charged sediments, methane hydrates, buried channels, and abnormal pressure zones.

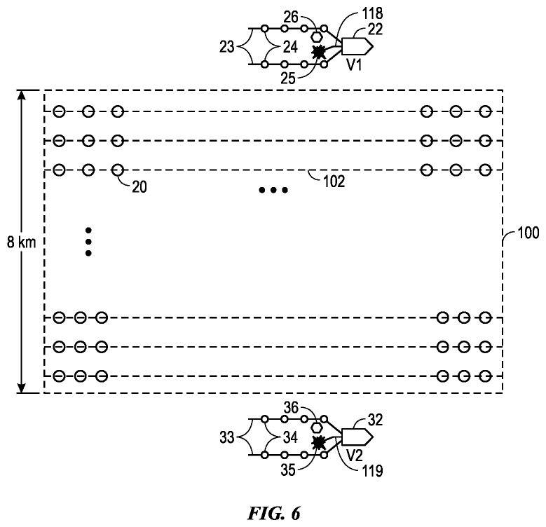

In certain embodiments, vertical seismic profile (VSP) sensors may be used to enhance the seismic data processing described above. FIG. 7 illustrates an example of vertical seismic profile (VSP) measurement simultaneously acquired with the OBN measurement, the short streamer measurement, and the NFH measurement. A seismic survey area where the OBN patch 100 is deployed may include a well 120 that is equipped with wireline cables (e.g., wireline cable 44), such as a Distributed Acoustic Sensing (DAS) fiber-optic cable or a hybrid DAS-VSP cable. The DAS fiber-optic cable may include multiple optical sensors (e.g., fiber-optic sensors 46). The hybrid DAS-VSP cable may include multiple fiber-optic sensors and other types of seismic sensors (e.g., geophones 48). When the wireline cables are deployed during an OBN survey, a 3D VSP may be acquired from the shots generated in the OBN survey. In some embodiments, the size of the OBN shot grid that may be used to image a subsurface target (e.g., reservoir) with receivers or sensors deployed in the wells may be based on a seismic modeling process (e.g., 3D finite difference modeling) and a seismic imaging process (e.g., Reverse Time Migration® imaging).

The VSP measurement may provide additional information for estimating physical properties of the subsurface layers and formations, such as anisotropy and attenuation factor (Q factor). Such physical properties may improve subsurface imaging quality and resolution that may facilitate identifying hydrocarbon deposits. Anisotropy may represent predictable variations of a property of a material (e.g., sediments) with the direction in which it is measured. In seismology, the anisotropy is a term that may be used in to describe directional dependences of the velocities of seismic waves in a medium (e.g., rock) within the Earth. For example, a variation of seismic velocity measured parallel or perpendicular to a sediment rock bedding surface is a form of anisotropy. Incorporating the anisotropy into a seismic velocity model may provide enhancement over the seismic imaging quality and resolution and reduce uncertainties on internal or bounding-fault positions. The Q factor may be a dimensionless quality factor representing a ratio of peak energy of a seismic wave to dissipated energy. As the seismic wave travels, it lose energy with distance and time due to spherical divergence and absorption. Such energy loss has to be accounted for when restoring seismic amplitudes to perform fluid and lithologic interpretations, such as amplitude versus offset (AVO) analysis.

By including the VSP measurement, the 3D VSP data may be used to calibrate travel times (e.g., times elapsing between initiations of shots and arrivals of reflected or refracted seismic impulses at sensors) and signal amplitudes in surface seismic data. The calibrated travel times may allow more accurate anisotropic estimations (e.g., anisotropic velocity depth model) to be derived. Such anisotropic estimations may improve a velocity model building (e.g., anisotropic velocity depth model) that may enhance images of subterranean geologic structures. For example, high-resolution image of the reservoir may be derived from the 3D VSP data. The calibrated signal amplitudes in the surface seismic data may be used to improve identifications of horizons (e.g., distinctive rock layers represented by reflections in seismic data) that may be related to internal multiples (e.g., inter-bed multiples) and enable identifications of amplitude variation with azimuth and offset. In some embodiments, amplitude calibrations of the surface seismic data may be used to improve estimations of the attenuation factors (Q factors) of the subsurface structures. Moreover, acquiring the 3D VSP data during an OBN survey may reduce a cost of the VSP measurement since the main cost of a VSP survey is related to shot generations.

In certain cases, multiple wells may be present in a shallow water survey area where Distributed Acoustic Sensing (DAS) fiber-optic cables may be deployed. The shallow water survey area may include various obstructions, such as offshore rigs, platforms, pipelines, or other oil and gas facilities that may inhibit deployments of OBNs and/or streamers. In such cases, multiple 3D VSPs may be acquired simultaneously during an OBN survey.

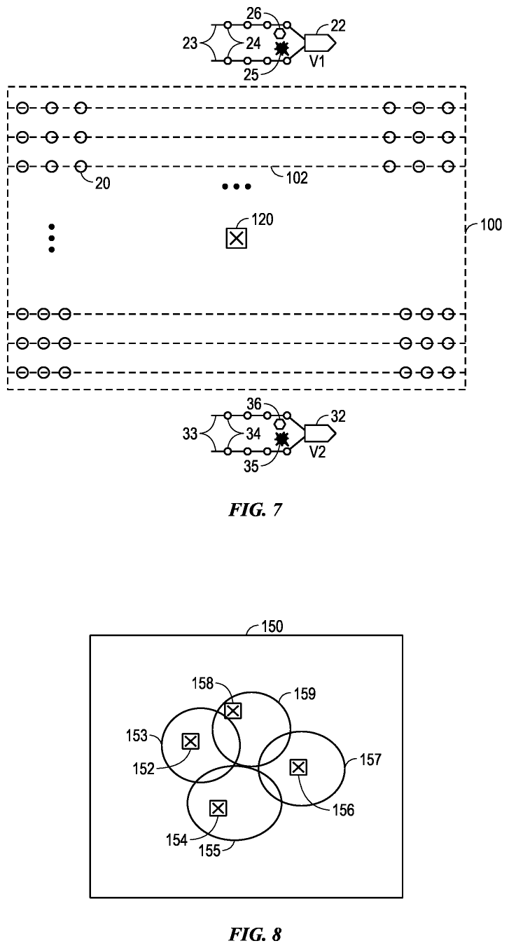

FIG. 8 illustrates an example of multiple VSPs simultaneously acquired with the OBN measurement to generate a continuous image of a reservoir in an obstructed area. Four wells, including wells 152, 154, 156, and 158, may be present inside an OBN source grid 150. As described previously, the OBN source grid 150 may have a dense source samplings (e.g., 37.5 meters×50 meters shot spacing). Four 3D VSPs may be acquired simultaneously during an OBN survey using the OBN source grid 150. Each 3D VSP may be used to image a subsurface target area around a corresponding well. For example, subsurface target areas 153, 155, 157, and 159 may be imaged using corresponding 3D VSP acquired by the wells 152, 154, 156, and 158, respectively. The subsurface illumination for a reservoir around each well from each 3D VSP may create a continuous image of the reservoir by combining multiple 3D VSPs. For instance, the obstructed area may have holes in reservoir illumination as the seismic vessels carrying sources or receivers may not navigate close to rigs or platforms. Similarly, OBNs may not be deployed close to pipelines. The multiple 3D VSPs may fill the holes in reservoir illumination, therefore improving reservoir imaging quality and resolution.

As described above, short streamer data, near-field hydrophone (NFH) data, and vertical seismic profile (VSP) data may be simultaneously acquired with ocean bottom node (OBN) data in shallow water areas. However, performing coordinated seismic data processing using multiple types of seismic data acquired by different seismic sensors may be challenging. For example, shallow water properties and complex overburden may create challenges in seismic data processing (e.g., attenuating surface and internal multiples) or velocity model building. FIG. 9 illustrates a flow diagram of a process for processing multiple types of seismic data acquired in a shallow water seismic survey (e.g., in FIG. 1). Although the method described in FIG. 9 is described in a particular order and as being performed by a particular component, it should be understood that the method may be performed in any suitable order and by any suitable computing device or application.

Referring now to FIG. 9, the processor 86 of the processing system 80 may receive multiple types of seismic data acquired simultaneously from different sensors (process block 200). The multiple types of seismic data may include the OBN data, the short streamer data, the NFH data, and the VSP data. Different types of seismic data may be received by different data recording components. For example, the OBN data acquired by the OBNs 20, the short streamer data acquired by the streamer sensors 24 and 34, the NFH data acquired from the NFHs 26 and 36, and a portion of the VSP data acquired from geophones 48 may be received by the one or more seismic recorders 82, and another portion of the VSP data acquired by the fiber-optic sensors 46 may be received by the light recorder 96 of the interrogator 84. The received multiple types of seismic data may be sent to the processor 86. Although the multiple types of seismic data are described as including the sets of data mentioned above, it should be noted that additional types of seismic data may be employed in the method described herein.

Using processor-executable code stored in the memory 88 and the storage 90, the processor 86 may perform coordinated seismic data processing using the multiple types of seismic data to generate seismic data with reduced multiple contamination and increased coverage of subsurface targets (process block 202). The seismic data processing may include various sequences including, but are not limited to preprocessing, deconvolution, common midpoint (CMP) sorting, velocity analysis, normal moveout (NMO) correction, multiple attenuation, dip movemout (DMO) correction, CMP stacking, post-stack processing, and any other suitable sequences. The generated multiple-free seismic data may be stored in the storage 90 for later usage. Processing results may be displayed via the one or more displays 92.

By including the multiple types of seismic data, the seismic data processing may be performed in a coordinated manner. In some embodiments, the surface and internal multiples may be attenuated more effectively using the seismic data simultaneously acquired from the different sensors. For example, high-resolution streamer data acquired simultaneously with OBN data may be used together to generate predicted OBN multiples. The predicted OBN multiples may be subtracted from the OBN data to generate the multiple-free seismic data. In some embodiments, the streamer data may have a gap in small offsets. The NFH data may provide small-offset data missing from the streamer data that may be useful for multiple attenuation and increase coverage of subsurface targets. Additionally, the NFH data may be combined with the streamer data to improve wavelet estimation and de-bubble. In other embodiments, surface seismic data (e.g., streamer data) may be calibrated using the VSP data in terms of travel times and amplitudes. Such calibrations may improve accuracies of velocity model building, imaging, and interpretation.

At process block 204, the processor 86 may build a velocity model with increased accuracy based on the processed seismic data. The velocity model may map depth and thickness of the subsurface layers and formations. The velocity model may include parameters representing physical properties of the subsurface layers and formations such as velocities of seismic waves in different subsurface layers and formations. An initial velocity model may be built based on outputs (e.g., velocity picks) from the velocity analysis. The high resolution streamer data combined with OBN and NFH data may provide better inputs (e.g., data with higher resolution, less multiple contamination, more offset coverage) for the velocity analysis, therefore improving an accuracy of the velocity model.

In some embodiments, the VSP data may be used to in the velocity model building. For example, the VSP data may be used to calibrate the velocities of certain subsurface areas that are close to the wells where the VSP data is acquired. In some embodiments, other physical properties, such as anisotropies and attenuation factors (Q factors) may be incorporated into the velocity model. Incorporating the anisotropies may provide enhancement over the seismic imaging quality and resolution and reduce uncertainties on internal or bounding-fault positions. The Q factors may enable restoring seismic amplitudes to perform fluid and lithologic interpretations (e.g., amplitude versus offset (AVO) analysis). The VSP data may be used to calibrate surface seismic data (e.g., streamer data, NFH data) in terms of travel times that are related to anisotropy, Q-attenuation, and signal amplitudes.

The velocity model building may use various methods such as tomography and full waveform inversion (FWI). The improved seismic acquisition designs (e.g., combined OBN, streamer, NFH, and VSP measurements) and resulting seismic data may enable enhance velocity model building. For example, tomography based on Q factors may provide improved models to account for geological anomalies which may distort amplitude and phase.

The processor 86 may generate high-resolution images of subsurface targets based on the velocity model (process block 206). The multiple types of seismic data acquired simultaneously from different sensors, the coordinated seismic data processing using the multiple types of seismic data, and the velocity model with increased accuracy based on the process seismic data may improve images of the water bottom, shallow geologic structures, and reservoirs in resolution and accuracy. Such improved images may be used to reveal potential hydrocarbon deposits in shallow water seismic survey areas. For instance, multiple 3D VSPs acquired simultaneously in an obstructed area may fill holes in reservoir illumination, therefore improving reservoir imaging quality and resolution

The processor 86 may use seismic migration to generate subsurface images using the velocity model. Seismic migration is a process by which seismic events (e.g., subsurface reflections) are geometrically re-located in either space or time to the location where they occurred in the subsurface rather than the location where they were recorded at the surface, thereby creating a more accurate image of the subsurface. For example, seismic migration may move dipping reflectors to their true subsurface positions and collapses diffractions, resulting in migrated images having increased spatial resolution that may resolve areas of complex geology (e.g., shallow water complex geologic areas).

Various seismic migration methods may be used to generate the high-resolution images of the subsurface targets including, but are not limited to, Kirchhoff migration, Reverse Time Migration® migration, Gaussian Beam Migration, Wave-equation migration, and so on.

At process block 208, the processor 86 may interpret the high-resolution images to identify potential hydrocarbon deposits (process block 208). Seismic interpretation is a process to extract subsurface geologic information from seismic data. For example, the seismic interpretation may be used to infer geologies at certain depth from the processed seismic record such as the high-resolution images generated at process block 206. The improved accuracy of the reservoir image and signal amplitudes may enable better seismic interpretation such as reservoir characterization that simulates fluid behavior within the reservoir under different sets of circumstances and helps increasing oil and gas productions.

Although certain specific values (e.g., 50 meters shot spacing, 200 meters receiver spacing) are used to describe disclosed embodiments, they should be understood as approximate values and may be more or less than 5-10% of the listed values.

While only certain features of disclosed embodiments have been illustrated and described herein, many modifications and changes will occur to those skilled in the art. It is, therefore, to be understood that the appended claims are intended to cover all such modifications and changes as fall within the true spirit of the present disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
a plurality of sources configured to generate a plurality of source waves, wherein the plurality of sources comprises a first source and a second source, wherein each of the first source and the second source comprises a plurality of air guns;
a plurality of ocean bottom nodes configured to acquire a first set of seismic data in response to the plurality of source waves being generated by the plurality of sources, wherein the plurality of ocean bottom nodes is positioned along a plurality of receiver lines parallel to each other on a water bottom, wherein the plurality of receiver lines forms a receiver patch, wherein each pair of adjacent receiver lines of the plurality of receiver lines are separated by a distance, wherein each pair of adjacent ocean bottom nodes on a corresponding receiver line are separated with the distance; and
a plurality of streamer sensors configured to acquire a second set of seismic data simultaneously while the plurality of ocean bottom nodes is acquiring the first set of seismic data, wherein the plurality of streamer sensors is disposed on a plurality of streamers comprising a first group of streamers and a second group of streamers, wherein the first source and the first group of streamers are towed by a first vessel and the second source and the second group of streamers are towed by a second vessel, wherein the first vessel and the second vessel are configured to sail along a sail line direction outside area comprising the receiver patch, and wherein the sail line direction is parallel to the plurality of receiver lines of the receiver patch.

2. The system of claim 1, wherein each of the first source and the second source comprises a source array comprising a plurality of sources, wherein each pair of adjacent sources of the plurality of sources are separated by a spacing ranging from 47.5 meters to 52.5 meters along a direction perpendicular to the sail line direction.

3. The system of claim 2, wherein each source of the plurality of sources is fired alternatively in a flip-flop-flap mode with an interval ranging from 12 meters to 13 meters along the sail line direction.

4. The system of claim 1, wherein the distance comprises 200 meters.

5. The system of claim 1, wherein each of the plurality of streamers comprises a streamer having a length less than 3 kilometers.

6. The system of claim 5, wherein the first vessel and the second vessel are configured to sail on a same side of the receive patch and are separated from each other by the length along the sail line direction.

7. The system of claim 6, wherein the second set of seismic data comprises offset data having a maximum offset equal to three times of the length along the sail line direction.

8. The system of claim 5, wherein the first vessel and the second vessel are configured to sail on different sides of the receive patch.

9. The system of claim 8, wherein the second set of seismic data comprises offset data having a maximum offset equal to a dimension of the area of the receiver patch along a direction perpendicular to the sail line direction.

10. The system of claim 1, comprising a plurality of near field hydrophones configured to acquire a third set of seismic data simultaneously while the plurality of ocean bottom nodes is acquiring the first set of seismic data, wherein each of the plurality of near field hydrophones is positioned adjacent to at least one of the plurality of air guns, wherein the third set of seismic data comprises a plurality of near field hydrophone signatures.

11. The system of claim 10, wherein each of the plurality of near field hydrophones is positioned above a corresponding air gun of of the plurality of air guns.

12. The system of claim 1, comprising a plurality of vertical seismic profile sensors configured to acquire a fourth set of seismic data simultaneously while the plurality of ocean bottom nodes is acquiring the first set of seismic data, wherein the plurality of vertical seismic profile sensors is disposed in one or more wells located within the area of the receiver patch.

13. The system of claim 12, wherein a subset of the plurality of vertical seismic profile sensors is disposed along a wireline cable positioned in a corresponding well of the one or more wells in a vertical arrangement orthogonal to a plane that corresponds to the receiver patch.

14. A method, comprising:
receiving, via a processor, a plurality of seismic datasets, wherein each seismic data set of the plurality of seismic datasets is acquired simultaneously in response to a plurality of seismic waves generated by a plurality of sources towed by one or more vessels sailing along a sail line direction, wherein the plurality of seismic datasets comprise:
a first seismic dataset acquired from a receiver patch comprising a plurality of ocean bottom nodes positioned on a plurality of lines parallel to each other on a water bottom, wherein the plurality of lines is parallel to the sail line direction;
a second seismic dataset acquired from a plurality of streamers towed by the one or more vessels while sailing along the sail line direction and outside the receiver patch;
a third seismic dataset acquired from a plurality of near field hydrophones positioned adjacent to at least one of the plurality of sources; and
a fourth seismic dataset acquired from a plurality of vertical seismic profile sensors disposed in one or more wells located within the receiver patch;
performing, via the processor, coordinated seismic data processing using the plurality of seismic datasets to generate seismic data representative of one or more subsurface regions below the water bottom;
building, via the processor, a velocity model based on the seismic data, wherein the velocity model comprises a map of one or more velocity vectors within the one or more subsurface regions; and
generating, via the processor, one or more seismic images based on the velocity model, wherein the one or more seismic images are representative of the water bottom and the one or more subsurface regions.

15. The method of claim 14, wherein the coordinated seismic data processing comprises:
applying a convolution to the first seismic dataset and the second seismic dataset, wherein the convolution is configured to generate one or more predicted multiples; and
removing the one or more predicted multiples from the first seismic dataset.

16. The method of claim 14, wherein the coordinated seismic data processing comprises providing small-offset data to the second seismic dataset based on the third seismic dataset, wherein the small-offset data is missing from the second seismic dataset.

17. The method of claim 14, wherein the coordinated seismic data processing comprises calibrating one or more travel times and one or more amplitudes of the second seismic dataset based on the fourth seismic dataset.

18. A non-transitory computer-readable medium comprising instructions that, when executed, cause a processor to:
receive a plurality of seismic datasets, wherein each seismic data set of the plurality of seismic datasets is acquired simultaneously in response to a plurality of seismic waves generated by a plurality of sources towed by one or more vessels sailing along a sail line direction, wherein the plurality of seismic datasets comprise:
a first seismic dataset acquired from a receiver patch comprising a plurality of ocean bottom nodes positioned on a plurality of lines parallel to each other on a water bottom, wherein the plurality of lines is parallel to the sail line direction;
a second seismic dataset acquired from a plurality of streamers towed by the one or more vessels while sailing along the sail line direction and outside the receiver patch;
a third seismic dataset acquired from a plurality of near field hydrophones positioned adjacent to at least one of the plurality of sources; and
a fourth seismic dataset acquired from a plurality of vertical seismic profile sensors disposed in one or more wells located within the receiver patch;
perform coordinated seismic data processing using the plurality of seismic datasets to generate seismic data representative of one or more subsurface regions below the water bottom;
build a velocity model with based on the seismic data, wherein the velocity model comprises a map of one or more velocity vectors within the one or more subsurface regions, wherein building the velocity model comprises calibrating a plurality of parameters of the velocity model based on the fourth seismic dataset, wherein the plurality of parameters comprises a velocity parameter, an anisotropy parameter, and one or more attenuation factors of the one or more subsurface; and
generate one or more seismic images based on the velocity model, wherein the one or more seismic images are representative of the water bottom and the one or more sub surface regions.

19. The non-transitory computer-readable medium of claim 18, wherein generating the one or more seismic images comprises generating a zero offset image of the one or more subsurface regions using the third seismic dataset comprising one or more near field signatures acquired for each of the plurality of sources.

20. The non-transitory computer-readable medium of claim 18, wherein the fourth seismic dataset comprises one or more vertical seismic profiles, wherein each of the one or more vertical seismic profiles corresponds to a well of the one or more wells, wherein generating the one or more seismic images comprises:
supplementing one or more portions in a subsurface illumination of a reservoir based on the one or more vertical seismic profiles; and
generating a continuous image of the reservoir based on the one or more supplemented portions.
